(19) United States
(12) Patent Application Publication
(10) Pub. No.: US 2005/0032494 A1
(43) Pub. Date: Feb. 10, 2005

(54) Receiver test system

(76) Inventor: John M. Swant, (US)

Correspondence Address: Charles A. Mirho, 112 W. 37th St., Vancouver, WA, 98660, US

(21) Appl. No.: 10/634,977

(22) Filed: Aug. 4, 2003

(51) Int. Cl. H04B 17/00; H04Q 7/20

(52) U.S. Cl. 455/226.1; 455/423; 455/424; 455/425; 455/67.11; 455/67.14

(57) ABSTRACT

Performance of receivers can be determined by automated or manual testing of receivers without interrupting communication service to users of the communication system. In one embodiment, the system measures the performance of a deployed base station receiver without interrupting cellular service to subscribers registered with the base station.

### TECHNICAL FIELD

The present disclosure relates to measuring performance of communication system hardware and, in particular, relates to testing of receivers.

### BACKGROUND

Many types of wireless communication networks exist to serve society's increasing desire to be “connected” at all times. Some examples are mobile telephone systems such as cellular networks, wireless local-area-networks (WLAN) such as IEEE 802.11 compliant networks, wireless wide-area networks (WWAN), short range RF systems such as Bluetooth, and fixed wireless broadband networks. Mobile telephone systems commonly include a variety of services and functions beyond simple direct voice communication. There are many more types of wireless communication networks in use.

FIG. 1 shows a functional block diagram of a typical cellular network 100. A radio subsystem 105 includes all the radio-related functions of the network: a mobile station (MS) 110 and the base station subsystem 115. The base station subsystem (BSS) 115 consists of base station controllers (BSC) 120 coupled to one or more base transceiver stations (BTS) 125. In turn, each BTS 125 is coupled to one or more antenna subsystems 130. Entities within a cellular network, such as, but not limited to, MS 110, BSS 115, BSC 120, or BTS 125, are sometimes referred to generically as network elements.

The BTS 125 includes all the transmitting and receiving equipment necessary to create the radio interface between the cellular network 100 and the mobile station 110. Although the antenna subsystem 130 is shown as a separate element in FIG. 1 for clarity, it is common in the industry to collectively refer to the antenna subsystem, transmitter, and receiver, as the BTS.

The BSC 120 is responsible for management of the radio interface by allocating channels, managing MS handover from one BTS to another, paging MS, and transmitting connection-related signaling data.

The networking and switching subsystem (NSS) 135 of the network includes at least one Mobile Switching Center (MSC) 140, one Home Location Register (HLR) 145, and one Visitor Location Register (VLR) 150. Switching and network management functions are carried out in the NSS 135. The NSS 135 also forms the gateway network between the cellular network 100 and other networks such as the Public Switched Telephone Network (PSTN), Integrated Digital Services Network (ISDN), the Internet, other cellular networks, and the Public Switched Data Network (PDN).

The MSC 140 is a digital switching mechanism that routes communications and manages the network. There can be many MSC 140 in a communication network, each responsible for the signaling required to set up, maintain, and terminate connections to mobile stations 110 within the geographical area served by the MSC 140. Each MSC 140 may control several BSC 120. MSC 140 is coupled to HLR 145 and VLR 150. HLR 145 is coupled to VLR 150.

Important subscriber information, including telephone number, mobile station identification number, equipment type, subscription information, access priorities and authentication key, is stored in HLR 145, which is essentially a database. Also, HLR 145 stores certain dynamic or temporary subscriber data such as current Location Area (LA) of the subscriber's mobile station and Mobile Station Roaming Number (MSRN). Each mobile subscriber and his related data are registered in an HLR from which billing and administrative information is extracted when needed by the cellular service provider. Some cellular networks have only one HLR that serves all subscribers.

MSC 140 uses VLR 150 to manage the mobile stations that are currently roaming in the area controlled by MSC 140. VLR 150 stores information such as International Mobile Subscriber Identity (IMSI), authentication data, and telephone number of the roaming mobile stations. VLR 150 obtains information about the services to which a roaming mobile station is entitled from the HLR that serves the mobile station. The VLR 150 controls a pool of MSRN and allocates an MSRN and Temporary Mobile Subscriber Identity (TMSI) to the roaming mobile station. The VLR 150 sends the MSRN and TMSI information to the HLR 145 where they are stored with the subscriber's dynamic records for later use in call routing.

The operation subsystem (OSS) 155 includes an Equipment Identity Register (EIR) 160, an Authentication Center (AuC) 165, and an Operating and Maintenance Center (OMC) 170. The OSS 155 is generally responsible for subscription management, network operation, network maintenance, and mobile equipment management. The OSS 155 extracts call data from the HLR 145 in order to bill the subscriber.

The AuC 165 stores data related to network security and authentication of mobile devices and subscribers. The AuC 165 functions to prevent fraud by verifying the identity of mobile devices and subscribers that try to access the network. Thus the AuC 165 contains authentication algorithms and encryption codes necessary to protect a subscriber's access rights and identity and to prevent eavesdropping.

The EIR 160 is a database which stores subscriber and International Mobile Equipment Identity (IMEI) numbers. Mobile stations are uniquely identified by an IMEI or equivalent number such as an Electronic Serial Number (ESN). An EIR 160 generally indicates the status of a particular mobile station by flags associated with its IMEI. An IMEI is typically flagged as one of either valid, stolen, suspended, or malfunctioning.

The OMC 170 monitors and controls other network elements to enhance system performance and quality. The OMC 170 also administers billing, subscriber service data, and generation of statistical data on the state and capacity of the network. Although omitted from FIG. 1 for clarity, the OMC 170 is typically coupled to many other network elements.

In general, cellular service providers, like most communication service providers, do not manufacture the computers and other infrastructure necessary to create and maintain a cellular network.

Rather, most service providers purchase network infrastructure from vendors. Some well-known infrastructure vendors are Nortel, Ericsson, Cisco, and Nokia.

Vendors of wireless communication network infrastructure provide transceivers that support at least some capabilities to measure and maintain the system radio hardware. Transmitter diagnostics are easily accomplished using measurement detectors and software. Most vendors provide adequate transmitter diagnostics in order to maintain transmission quality while a transceiver is deployed in the field. Receiver diagnostics, however, have not been adequately addressed by the vendors.

It has always been difficult to test performance of receivers in the field. Historically, true receiver sensitivity testing of analog receivers could only be accomplished by taking manual control of the radios on-site. Often this on-site performance testing required special test software, hardware, and test equipment (such as signal generators).

Unfortunately, digital receivers are not capable of being performance tested in the same manner as analog receivers. As a result, network operators have generally fallen back on statistical methods of monitoring of digital receiver performance. In the case of cellular network operators, peg counters for dropped calls or call starts are a commonly used receiver performance metric.

Additionally, some cellular receiver vendors have implemented an automatic “path test” that verifies that the input and output cables remain connected to the receiver.

Modern communication networks have no way to determine the actual performance of field-deployed receivers. In most cellular communication networks, it is especially difficult to field test receivers because the air interface is constantly powering the mobile up and down. Thus, poorly performing receivers that cause degraded network performance must be located by an expensive and time consuming process of trial and error. Often, however, lack of adequate methods to field test receivers means that the source of network problems cannot be identified.

There is a need for a system that addresses the above problems, as well as providing additional benefits.

### SUMMARY

The present invention addresses the limitations of the prior art and provides additional benefits. A brief summary of some embodiments and aspects of the invention are first presented. Some simplifications and omissions may be made in the following summary; the summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the Figures, and from the claims (which follow the detailed description).

Embodiments of the disclosed receiver test system may provide automated or manual testing of receivers without interruption of service by the receiver. An embodiment used in cellular networks may provide automated or manual testing of base station receivers without service interruption to the cell site. An embodiment of the invention may serve as a test platform across a variety of cellular communication systems such as IS-136, GSM, CDMA, and AMPS compliant systems.

One embodiment of the invention discloses a receiver test unit having a controller, a programmable attenuator, a mobile station, and a power measurement device. The controller is capable of initiating a communication link to a remote device such as an MSC test unit, wirelessly transmitting a predetermined message over the communication link via the mobile station, reading the received signal power of the predetermined message at a point prior to the incoming-signal input of the receiver-under-test via the power measurement device, and adjusting the attenuation of subsequent transmissions of predetermined messages in accordance with the received signal power measurement. The performance of the receiver-under-test can then be determined by its ability to reconstruct the predetermined message at various transmission attenuations from the receiver test unit.

### BRIEF DESCRIPTION OF THE DRAWINGS

FIG. 1 is a functional block diagram of a cellular communication network.

FIG. 2 shows a block diagram of the disclosed testing system in an embodiment for testing radio receivers.

FIG. 3 shows a block diagram of a BTS Test Unit (BTU) for use with the system of FIG. 2.

FIG. 4 shows a block diagram of a MSC Test Unit (MTU) for use with the system of FIG. 2.

FIG. 5 shows a flow diagram of a method for testing a receiver for use with test systems such as that shown in FIG. 2.

The headings provided herein are for convenience only and do not necessarily affect the scope or meaning of the claimed invention.

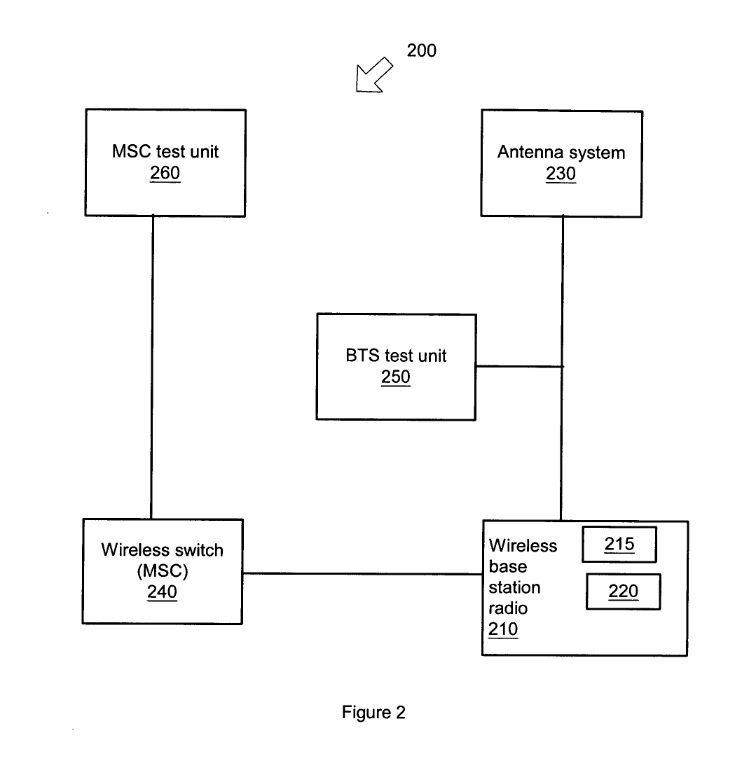

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 250 is first introduced and discussed with respect to FIG. 2).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details.

In other instances, well known structures and functions have not been shown or described in detail to avoid unnecessarily obscuring the description of the embodiments of the invention.

An embodiment of the invention is shown in a radio base station receiver testing system 200 of FIG. 2. A cellular radio base transceiver station 210 having a transmitter 215 and receiver 220 is coupled to an antenna system 230, a wireless switch (MSC) 240 and a base station transceiver test unit (BTU) 250. MSC 240 is coupled to MSC Test Unit (MTU) 260. In the embodiment shown in FIG. 2, receiver 220 is the receiver-under-test.

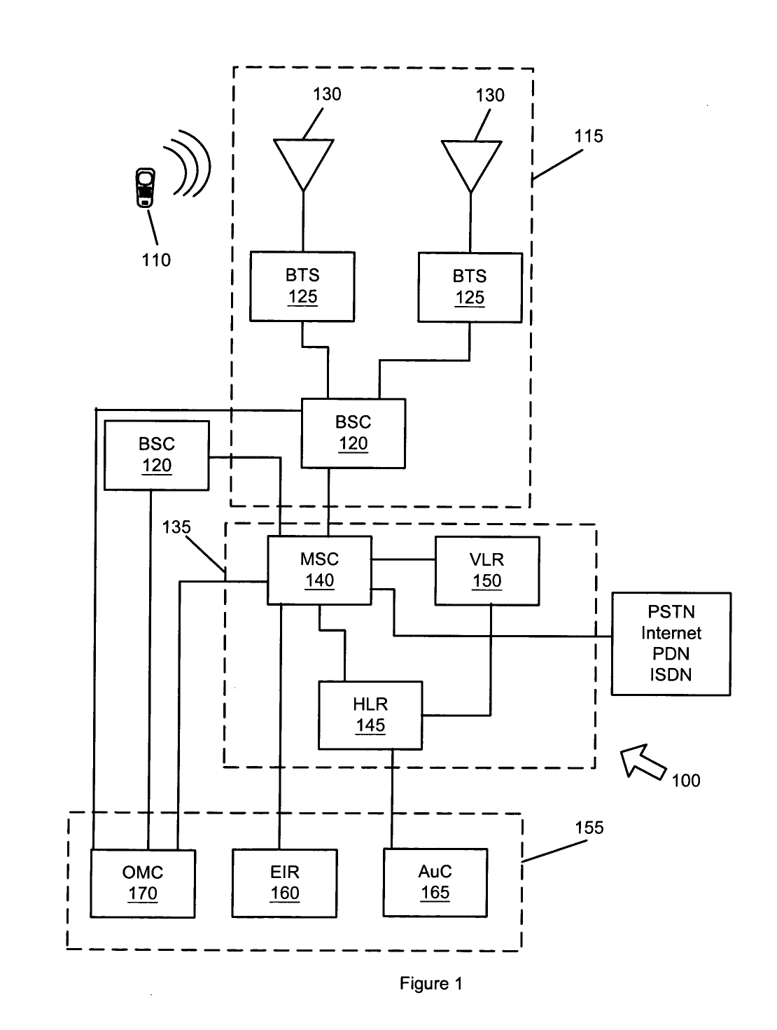

Some elements typical to cellular communication networks such as those shown in FIG. 1 have been omitted from FIG. 2 for ease of explanation but are understood to be present by one of ordinary skill in the art. For example, a BSC, HLR, and VLR, have been omitted from FIG. 2.

A feature of some embodiments of the present invention, such as that shown in FIG. 2, is that the BTU 250 and MTU 260 can communicate using the existing cellular system. For example, a wireless connection can be initiated between the BTU 250 and the MTU 260 by placing a normal call from the MTU 260 to the BTU 250.

Then, commands or data from the MTU 260 to the BTU 250, or vice-versa, would be routed by MSC 240 through the communication network to transceiver station 210, where they would be broadcast to BTU 250 via antenna system 230. Alternatively, any wireless transmitter such as nearby base station radios, not just the base station radio under test (which perhaps is being tested because it may not be functioning correctly), capable of communicating with BTU 250 could be used to send instructions. In an alternative embodiment, BTU 250 and MTU 260 could exchange data (such as the predetermined messages to be transmitted by the BTU 250) and commands through wired connections such as the Public Switched Telephone Network (PSTN) or private networks such as company intranet.

Although the MTU 260 and BTU 250 have been discussed above primarily in the context of separate devices located at separate physical locations, one of ordinary skill in the art understands that the MTU 260 and BTU 250 could be co-located in or near the same physical location. In fact, at least some functions of the MTU 260 could be combined into the BTU 250 resulting in a device which can place a call to itself via the base station transceiver 210 without routing the call through other network devices such as MSC 240.

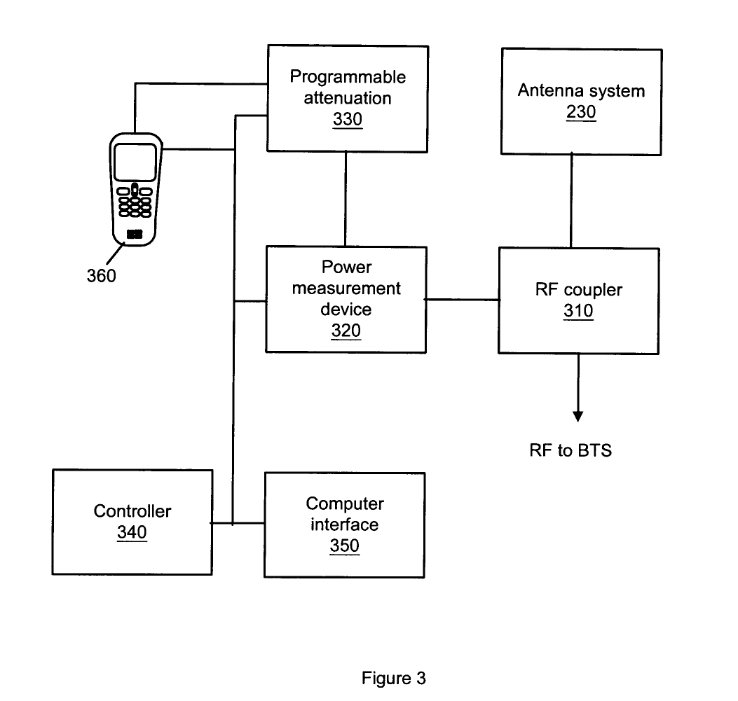

FIG. 3 shows an embodiment of BTU 250. The BTU 250 is coupled to antenna system 230 and cellular radio base station 210 by a RF coupler 310. A power measurement device 320 is coupled to a programmable attenuator 330, a controller 340, a computer interface 350, and a mobile station 360. In the embodiment shown, controller 340, mobile station 360, programmable attenuator 330, computer interface 350 and power measurement device 320 are coupled via a common communication bus 370.

Controller 340 can be any conventional sort of controller such as microcontroller or microprocessor based device. The actions of controller 340 would typically be regulated by software. Thus, controller 340 would access to computer instructions stored in on-board or off-board memory device such as RAM memory, ROM memory, hard disk, etc. In another embodiment, controller 340 could be a relatively unsophisticated device that is governed by an external computer and software via a computer interface or the common communication bus 370.

The mobile station 360 can be any wireless transceiver capable of communicating over the airlink with the receiver under test. For example, in a Global System for Mobile Telecommunications (GSM) cellular system, the mobile station 360 could be a GSM handset in combination with a GSM SIM card. In a Code Division Multiple Access (CDMA) cellular system, the mobile station 360 could be a CDMA compatible cellular phone.

FIG. 3 shows an embodiment of a receiver test unit (BTU) 250 for testing a receiver-under-test that includes a mobile station 360, power measurement device 320, programmable attenuator 330 and controller 340. The controller 340 is capable of initiating a wireless connection to the MTU 260 via the mobile station 360 and transmitting a predetermined message over the wireless connection. The controller 340 can vary the attenuation of the transmitted message by controlling programmable attenuator 330. Power measurement device 320 is used to detect the received power level of the transmitted signal prior to the receiver-under-test's input. Attenuation of the transmitted message could be automatically controlled by a feedback loop between power measurement device 320 and programmable attenuator 330 or controller 340 could receive the power measurement from power measurement device 320 and adjust the attenuation according to a predetermined routine stored in the memory of controller 340.

In the embodiment shown in FIG. 3, RF coupler 310 is a calibrated coupler with fixed attenuation. However, the type of coupler shown does not limit the scope of the invention because other types of coupler may be used with embodiments of the invention. Additionally, RF coupler 310 may be installed permanently or as-needed at a cell site.

FIG. 3 discloses a common communication bus 370 in BTU 250. A common bus is not required. Any means of providing the necessary communications between these elements is acceptable.

FIG. 3 discloses a mobile station 360. However, an RF module which is capable of emulating a mobile station may also be used. Such an emulator may be capable of wireless reception and transmission via a data channel, voice channel, control channel, or similar wireless link. Thus, a mobile station emulator or its equivalent may be used as a functional substitute for mobile station 360.

The various components of BTU 250 are shown in FIG. 3 as an integrated unit for convenience. It is not necessary that these components be contained in the same unit or even in the same physical location.

The computer interface 350 may be any interface which allows the BTU 250 to communicate with a computer or processor. Well-known examples are serial ports, parallel ports, Universal Serial Bus (USB) and Ethernet interfaces.

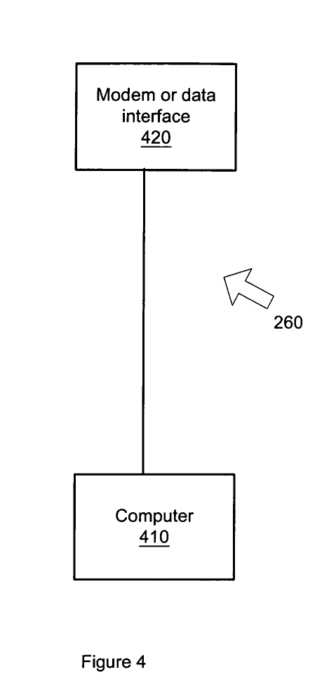

FIG. 4 shows details of an embodiment of the MSC Test Unit 260. A computer 410 is coupled to a communication interface 420. The MSC Test Unit 260 couples to MSC 240 by any method compatible with communication interface 420. In an embodiment where communication interface 420 is a modem or data interface, MSC Test Unit 260 may be coupled to MSC 240 by a phone line, T-1 line, or other method of digital or analog communication.

Computer 410 comprises test software. The test software allows MSC Test Unit 260 to communicate with the BTS Test Unit 250. Software typically comprises instructions for execution by a processor residing on a machine-readable medium, such as RAM, ROM, floppy disk, hard disk, CD-ROM, etc. Software generally comprises multiple routines or sub-routines that focus on executing particular tasks.

The BTS Test Unit 250 places a phone call to the MSC Test Unit 260. Alternatively, the MTU 260 could initiate a call or data link to the BTU 250. In the embodiment shown, the MSC Test Unit has the functional equivalent of a Mobile Identity Number (MIN). After the call between the BTU and the MSC Test Unit is established, the BTU 250 will generate a data signal consisting of a known bit pattern and modulate the RF carrier of mobile station 360. The BTU 250 uses programmable attenuator 330 to provide attenuation to the transmitted signal while measuring RF level at the RF coupler 310.

The MSC Test Unit 260 monitors the other end of the test call and decodes the known bit pattern in the signal transmitted by the BTU 250. By doing so, the MSC Test Unit can calculate a continuous receiver bit error measurement.

MSC Test Unit 260 and BTU 250 can communicate via the computer interface 350. Once communications between the two are established, the MSC Test Unit 260 can remotely activate the test process and monitor the test parameters such as transmission attenuation and received power. The MSC Test Unit 260 can command the BTU 250 to provide RF attenuation via the programmable attenuator 330 until either the call has reached a target measurement level or the call is dropped. Similarly, the MSC Test Unit 260 can access the received power measurements that power measurement device 320 obtains by monitoring the received RF signal via RF coupler 310.

The BTU controller 340 is coupled to the power measurement device and programmable attenuator, thereby allowing the controller 340 to determine the transmitted and received RF levels for the test.

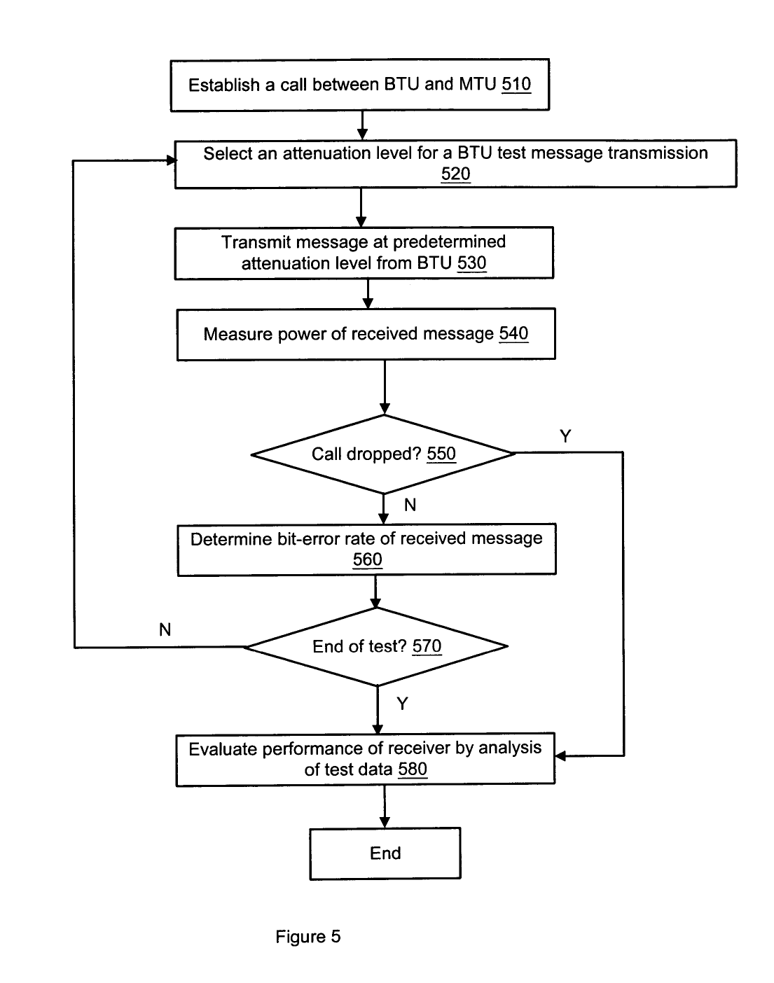

FIG. 5 shows a method of testing a receiver, such as a radio receiver, according to an embodiment of the present invention. In 510, a voice channel, data channel, or other suitable communication link is established between the BTU and MTU. A further example of a suitable communication link might be a data link to measure receiver performance during a data connection such as a General Packet Radio System (GPRS) session, an IEEE 802.11 WLAN session, or any other similar data transfer protocols. In one embodiment, the BTU could initiate a call or data connection to the MTU. In another embodiment, the MTU could initiate a call or data connection to the BTU.

In 520, an attenuation level is selected for a BTU Test Message transmission. The attenuation level can be selected automatically, by remote control, or by local manual control. In automatic mode, for instance, the BTU could be programmed to step through predetermined attenuation levels until the call is dropped.

In 530, the BTU transmits the Test Message over the wireless link to the receiving network's antenna system at the level determined in 520. In the case where the receiving network is a cellular system such as that shown in FIG. 2, the Test Message would be transmitted to, and received by, the antenna system 230. In the case where the receiving network is a WLAN, the Test Message would be transmitted to, and received by, the antenna coupled to the WLAN transceiver.

In 540, the BTU measures the power of the Test Message signal received at the antenna system. The measured value would then be recorded or stored on a computer readable medium by the BTU. Typical computer readable media may comprise RAM memory, ROM memory, hard disk, or floppy disk, CD-ROM, DVD, or other removable memory. For example, the BTU may write the measured power value into a database on a computer hard disk. Alternatively, the BTU could transmit the measured value to the MTU, MSC, or BTS for storage.

In 550, the communication network determines whether to drop the call. If the call is dropped, then the receiver performance is evaluated in 580. If the call is not dropped, then the Bit-Error Rate (BER) of the received Test Message is determined in 560. The BER can be determined by comparing the Test Message with its predetermined value or by other means such as by use of conventional error-detection coding schemes in the Test Message. After the BER rate is determined, it is stored for later retrieval. It could be stored at any of several suitable locations, including the BTU, the MTU, the BTS, or the MSC.

If the test is not over, the method branches in 570 and returns to 520 and begins the process to send another test message transmission. If the test is over, the method branches in 570 to 580, where the performance of the receiver is evaluated by analysis of the test data. For example, the receiver performance may be evaluated by correlating the BER with the transmitted power level and/or the received power level. An alternative means of evaluating receiver performance would be evaluate speech quality, perhaps via voice recognition, frequency analysis, phoneme breakdown, or other well-known methods of measuring speech quality.

As discussed in the background section, many types of communication networks are known. Although the disclosed invention has been discussed primarily in the context of testing a cellular radio receiver, the invention is not dependent upon the frequency of the received signal. It is envisioned that the disclosed invention may be used to field test any sort of wireless receiver such as fixed wireless, broadband, microwave, WLAN, or optical receivers.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

Embodiments of the invention have generally been described above in the context of placing a call between the MTU 260 and the BTU 250. Those familiar with the communication field will understand that placing a call refers to establishing a communication link between MTU 260 and BTU 250 and that many equivalent sorts of communication links could work with embodiments of this invention. Thus, many sorts of communication links such as data or control links are also understood to be covered under the present disclosure.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the cellular communication systems described herein. These and other changes can be made to the invention in light of the detailed description.

In view of the many possible embodiments to which the principles of this invention may be applied, it should be recognized that the detailed embodiments are illustrative only and should not be taken as limiting the scope of the invention. Rather, the actual scope of the invention encompasses the disclosed embodiments and all equivalent ways of practicing or implementing the invention under the claims. I claim as my invention all such embodiments as may come within the scope and spirit of the following claims and equivalents thereto.

1. A method of testing performance of a receiver, the method comprising:
establishing a communication link between a transmitter and a receiver;
transmitting from the transmitter a signal bearing a predetermined message at a predetermined attenuation;
receiving the predetermined message at an antenna coupled to a receiver;
measuring the power of the signal received by the antenna at a point between the receiver and the antenna;
calculating a bit-error rate by comparing the receiver output to the predetermined message; and
determining receiver performance by evaluating the bit-error rate, the predetermined attenuation, and the received message power.

2. The method of claim 1 in which receiver is deployed in a communication network.

3. The method of claim 2 in which the communication network is a cellular network.

4. The method of claim 1 wherein the communication link is at least one selected from the group of a voice channel, a data channel, and a control channel.

5. The method of claim 1 further comprising:
increasing the magnitude of the predetermined attenuation until the communication link is dropped.

6. In a mobile communication network, comprising:
a radio base station receiver test system that transmits a predetermined message to a base station receiver at a predetermined attenuation, that measures received power at the antenna, that calculates the bit-error rate of the predetermined message received by the radio base station receiver, and determines receiver performance quality as a function of the bit-error rate, measured power and predetermined attenuation.

7. The system of claim 6 in which the communication network is a cellular communication network.

8. The system of claim 7 in which the cellular communication network is a GSM network.

9. In computer readable medium, a receiver testing application supporting field testing of base station receivers in a mobile communication network, comprising:
a routine for establishing a communication link between a transmitter and a receiver;
a bit-error rate detector routine that compares a received message to a predetermined message to determine errors in the received message;
a control routine for controlling transmission attenuation level of a signal bearing the predetermined message;
a communication routine for requesting measured power of received signals having the predetermined message; and
an evaluation routine for comparing the measured power, bit-error rate, and attenuation to determine receiver performance.

10. The medium of claim 9 in which the communication routine requests the measured power before the received message enters the receiver.

11. The medium of claim 9 in which the control routine increases the transmission attenuation level in response to the signal bearing the predetermined message.

12. The medium of claim 9 in which the communication routine requests the measured power from a power measurement device.

13. The medium of claim 9 in which the evaluation routine medium resides in a MSC test unit.

14. In a cellular communication network, a method of determining base station receiver performance, comprising:
transmitting a known message at a known attenuation level;
receiving the message at an antenna coupled to a base station receiver;
measuring the power of the received message;
transmitting the received message from the base station receiver to a network element;
calculating the bit-error rate of the received message at the network element; and
evaluating performance of the base station receiver by analysis of the bit-error rate in a plurality of received messages as a function of attenuation and received message power.

15. A receiver test unit, comprising:
a power measurement device;
an attenuator coupled to the power measurement device;
a mobile station; and
a controller coupled to the attenuator and the mobile station;
wherein, the controller is programmable to initiate a communication link via the mobile station to a remote device and transmit a predetermined message to said remote device.

16. The receiver test unit of claim 15, wherein the power measurement device is capable of being coupled between a receiver-under-test and the receiver-under-test's antenna.

17. The receiver test unit of claim 15, wherein the power measurement device measures the received signal power of the predetermined message at a point prior to a receiver-under-test's input.
